(19) United States
(12) Patent Application Publication
(10) Pub. No.: US 2011/0050965 A1
(43) Pub. Date: Mar. 3, 2011

(54) IMAGE CAPTURE DEVICE AND CONTROL METHOD THEREOF

(75) Inventor: Takeyoshi UZUMAKI, Saitama-shi (JP)

(73) Assignee: FUJIFILM CORPORATION, Tokyo (JP)

(21) Appl. No.: 12/873,910

(22) Filed: Sep. 1, 2010

(30) Foreign Application Priority Data
Sep. 3, 2009 (JP) 2009-203875

(51) Int. Cl. H04N 5/217

(52) U.S. Cl. 348/241; 348/E05.048

(57) ABSTRACT

First light receiving elements are exposed for a long exposure time TL, and second light receiving elements are exposed for a short exposure time TS. Just before an end of TS, high-speed idle transfer operation is carried out to output first and second noise charges accumulated during TS in first and second VCCDs as first and second noise signals, respectively. Then, by multiplying the second noise signal by a coefficient based on the ratio between TL and TS, a correction signal that corresponds to the amount of noise charges accumulated in the second VCCDs until an end of TL is calculated. The calculated correction signal is subtracted from a second image signal. A first image signal is merged with the corrected second image signal, and image data having a wide dynamic range is obtained.

### BACKGROUND OF THE INVENTION

1. Field of the Invention

The present invention relates to an image capture device that can take an image having a wide dynamic range, and a control method of the image capture device.

2. Description Related to the Prior Art

An image capture device that is provided with a solid-state image sensor such as a CCD or CMOS image sensor, e.g. a digital camera is widely available. The solid-state image sensor is typically required to have a large number of pixels and a wide dynamic range. As for the number of pixels, fine light receiving elements contribute to development of the solid-state image sensor of over ten million pixels, and the requirement is almost satisfied. As for the dynamic range, on the other hand, only structural improvement of the light receiving elements is not enough to adequately widen the dynamic range, because a charge storage capacity is decreased with reduction in size of the light receiving elements. Thus, an additional technique is necessary for widening the dynamic range.

Regarding the additional technique, the applicant discloses in Japanese Patent Laid-Open Publication No. 2007-235656 a solid-state image sensor that has a plurality of pairs of a first light receiving element and a second light receiving element, exposure times of which are separately controllable. In this solid-state image sensor, while the first light receiving elements capture a long exposure image with high sensitivity by being exposed for long time, the second light receiving elements capture a short exposure image with low sensitivity by being exposed for short time. In other words, the long exposure image captures a darker part of a scene, while the short exposure image captures a brighter part of the scene. Superimposing the long and short exposure images on each other produces a composite image having the wide dynamic range. Also, since the second light receiving elements are exposed during the exposure of the first light receiving elements, the simultaneousness between the long and short exposure images is obtained.

According to this technique, varying the ratio between the exposure time of the first light receiving elements and the exposure time of the second light receiving elements allows obtainment of the desired dynamic range. When the wide dynamic range is unnecessary, on the other hand, the exposure times of the first and second light receiving elements are equated. Output signals from the first and second light receiving elements are handled as separate pixel data that provides an image of high resolution.

In the Japanese Patent Laid-Open Publication No. 2007-235656, it is also proposed to emit flash light within the long exposure time and without the short exposure time, for the purpose of acquiring the wide dynamic range in flash photography. By emitting the flash light at this timing, a light amount (integrated exposure energy) is increased only during the exposure of the first light receiving elements, though the light amount is not changed during the exposure of the second light receiving elements.

In this case, the amount of flash light is determined based on the exposure time of the first light receiving elements. Although the first light receiving elements can receive an appropriate amount of flash light, the second light receiving elements cannot. Thus, this technique cannot achieve the desired dynamic range in the flash photography.

Accordingly, the applicant proposed in Japanese Patent Application No. 2009-203486 to adjust the timing of flash light emission, so that the ratio between the flash light amount produced during the long exposure and the flash light amount produced during the short exposure coincides with the ratio between the long exposure time and the short exposure time. FIG. 10 shows an example of a timing chart according to the Japanese Patent Application No. 2009-203486. According to FIG. 10, the first light receiving elements of the CCD image sensor start being exposed at T0, and the second light receiving elements start being exposed at T2. Then, both of the first and second light receiving elements end the exposure at T4. A rising edge T1 and a falling edge T3 of a flash trigger signal is so determined that the ratio between the flash light amount produced during the long exposure time TL (T0 to T4) of the first light receiving elements and the flash light amount produced during the short exposure time TS (T2 to T4) of the second light receiving elements coincides with the ratio between the long exposure time TL and the short exposure time TS.

In this case, the timing T4 of ending the exposure of the first and second light receiving elements is regulated by using a mechanical shutter. Thus, electric charges that are needlessly accumulated in vertical charge coupled devices (VCCDs) are abandoned by idle transfer operation and the VCCDs are refreshed, before read of signal charges accumulated in the first and second light receiving elements to the VCCDs. Therefore, the low noise composite image can be obtained with preventing the occurrence of smear and blooming.

The flash light amount, however, is gradually reduced at the falling edge, while being sharply increased at the rising edge, in general. Although this control method as shown in FIG. 10 is effective at producing the low noise image, the flash light amount is likely to vary in the short exposure time TS that contains the falling edge T3 of the flash trigger signal. Variations in the flash light amount produced during the short exposure time TS bring about variations in the dynamic range of the composite image.

Accordingly, a control method as shown in FIG. 11 is conceivable. In this method, both of the first and second light receiving elements start being exposed at T0. The first light receiving elements end the exposure at T4, and the second light receiving elements end the exposure at T2. The rising edge of the flash light emission is set at T1 within the short exposure time TS (T0 to T2), and the falling edge is set at T3 without the short exposure time TS, in order to prevent the variations in the dynamic range. In this method, however, the signal charges of the second light receiving elements are read to the VCCDs at T2. Thus, the idle transfer operation of the VCCDs cannot be carried out after completion of the long exposure time TL, that is, after T4. Also, since the flash light emission is continued even after the read of the signal charges from the second light receiving elements to the VCCDs, electric charges that are generated in the second light receiving elements and peripheral circuits thereof flood into the VCCDs, and are added to the signal charges. Therefore, the control method of FIG. 11 tends to cause the smear and the blooming, while can prevent the adverse effect of the variations in the flash light amount.

### SUMMARY OF THE INVENTION

An object of the present invention is to provide an image capture device and a control method of the image capture device that can produce an image having a wide dynamic range and low noise in flash photography.

To achieve the above object, an image capture device according to the present invention includes a flash lamp unit for emitting flash light, a CCD image sensor, an exposure control section for controlling exposure of the CCD image sensor, a flash control section, a noise correction section, and an image composition section. The CCD image sensor includes first light receiving elements for capturing a long exposure image, second light receiving elements for capturing a short exposure image, first VCCDs to which first signal charges are read out from the first light receiving elements to transfer the read first signal charges in a vertical direction, second VCCDs to which second signal charges are read out from the second light receiving elements at a time different from the readout of the first signal charges in order to transfer the read second signal charges in the vertical direction, a HCCD connected to an end of each of the first and second VCCDs for horizontally transferring the first and second signal charges transferred through the first and second VCCDs, and an output section for converting the first and second signal charges transferred through the HCCD into an analog signal and outputting the analog signal. The exposure control section makes the CCD image sensor produce a first image signal from the first signal charges read out from the first light receiving elements after the exposure for a long exposure time, and makes the CCD image sensor produce a second image signal from the second signal charges read out from the second light receiving elements after the exposure for a short exposure time. The exposure control section makes the CCD image sensor produce a first noise signal from first noise charges accumulated in the first VCCDs, and makes the CCD image sensor produce a second noise signal from second noise charges accumulated in the second VCCDs. The flash control section controls timing of flash light emission by the flash lamp unit, so as to equate a ratio between a flash light amount produced during the long exposure time and a flash light amount produced during the short exposure time with a ratio between the long exposure time and the short exposure time. The noise correction section removes noise from the second image signal based on the second noise signal. The image composition section merges the first image signal with the second image signal after correction by the noise correction section, to produce image data.

The exposure control section may start exposing the first and second light receiving elements at the same time. The second signal charges may be read out from the second light receiving elements to the second VCCDs after a lapse of the short exposure time, and held in the second VCCDs. The first signal charges may be read out from the first light receiving elements to the first VCCDs after a lapse of the long exposure time. The first signal charges are transferred by normal transfer operation together with the second signal charges that have been held in the second VCCDs. Just before the readout of the second signal charges from the second light receiving elements, the first and second VCCDs and the HCCD may be driven to transfer the first and second noise charges accumulated during the short exposure time in the first and second VCCDs by idle transfer operation. The noise correction section may calculate a second correction signal by multiplying the second noise signal produced from the second noise charges by a coefficient obtained based on the ratio between the long exposure time and the short exposure time. The noise correction section subtracts the second correction signal from the second image signal, and outputs the corrected second image signal. The second correction signal corresponds to the amount of noise charges added to the second signal charges, while the second signal charges are held in the second VCCDs.

The noise correction section may calculate a first correction signal by multiplying the first noise signal produced from the first noise charges by the coefficient obtained based on the ratio between the long exposure time and the short exposure time. The noise correction section subtracts the first correction signal from the first image signal, and outputs the corrected first image signal. The first correction signal corresponds to the amount of noise charges accumulated in the first VCCDs until an end of the long exposure time. The image composite section merges the corrected first image signal with the corrected second image signal to produce the image data.

It is preferable that a speed of the idle transfer operation be higher than that of the normal transfer operation.

Each of the first and second VCCDs may have a plurality of rows. In the idle transfer operation, out of all of the rows included in each of the first and second VCCDs, the first and second noise charges accumulated in a beginning predetermined number of rows may be transferred at a normal speed, while the first and second noise charges accumulated in the remaining rows are transferred at a high speed. Otherwise, the first and second noise charges accumulated in the beginning predetermined number of rows may be transferred at the normal speed, while the first and second noise charges accumulated in the remaining rows are left in the first and second VCCDs without being transferred. In either case, the first and second noise signals are produced from the first and second noise charges transferred at the normal speed.

It is preferable that the CCD image sensor have an electronic shutter function for simultaneously discharging the first and second signal charges accumulated in the first and second light receiving elements into a semiconductor substrate for reset. The electronic shutter function is activated before starting the exposure of the first and second light receiving elements.

The image capture device may further include an operation unit for setting a value of a dynamic range. The ratio between the long exposure time and the short exposure time is determined based on the set value of the dynamic range.

In the CCD image sensor, the first light receiving elements may be arranged in a matrix along the vertical and horizontal directions, and the second light receiving elements may be arranged in a matrix at a same pitch as that of the first light receiving elements along the vertical and horizontal directions. The first and second light receiving elements may be staggered in the vertical and horizontal directions. The first and second VCCDs extending in the vertical direction may be disposed alternately in the horizontal direction. The HCCD may extend in the horizontal direction.

A Bayer color filter including blue, green, and red may be disposed on the first light receiving elements, and another Bayer color filter including blue, green, and red may be disposed on the second light receiving elements.

A method for controlling an image capture device, having a flash lamp unit and a CCD image sensor, includes the steps of starting exposing the first and second light receiving elements at the same time; just before a lapse of a short exposure time, driving first and second VCCDs and a HCCD to transfer first noise charges accumulated in the first VCCDs and second noise charges accumulated in the second VCCDs by idle transfer operation, and producing a first noise signal from the first noise charges and producing a second noise signal from the second noise charges; after the lapse of the short exposure time, reading out second signal charges from the second light receiving elements to the second VCCDs, and holding the second signal charges in the second VCCDs; after a lapse of a long exposure time, reading out first signal charges from the first light receiving elements to the first VCCDs; after the readout of the first signal charges, driving the first and second VCCDs and the HCCD to transfer the first signal charges read out from the first light receiving elements and the second signal charges held in the second VCCDs by normal transfer operation, and producing a first image signal from the first signal charges and producing a second image signal from the second signal charges; controlling timing of flash light emission from a flash lamp unit so as to equate the ratio between a flash light amount produced during the long exposure time and a flash light amount produced during the short exposure time with the ratio between the long exposure time and the short exposure time; calculating a second correction signal by multiplying the second noise signal by a coefficient based on the ratio between the long exposure time and the short exposure time; subtracting the second correction signal from the second image signal, and outputting the corrected second image signal; and merging the first image signal with the corrected second image signal to produce image data.

According to the present invention, it is possible to obtain an image having a wide dynamic range and low noise in flash photography. In the present invention, the idle transfer operation for obtaining the noise signals is carried out while the first and second light receiving elements are exposed, and hence does not require increase in processing time for noise correction.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a block diagram of a digital camera according to a first embodiment of the present invention;

FIG. 2 is a top plan view of a CCD image sensor;

FIG. 3 is a timing chart for explaining a control method of the digital camera;

FIG. 4 is a block diagram of a noise correction section and an image composition section;

FIGS. 5A to 5C are explanatory views of noise correction processing;

FIG. 6 is a flowchart of the operation of the digital camera;

FIG. 7 is a timing chart for explaining a control method of a digital camera according to a second embodiment;

FIG. 8 is a timing chart for explaining a control method of a digital camera according to a third embodiment;

FIG. 9 is a block diagram of a noise correction section according to a fourth embodiment;

FIG. 10 is a timing chart of a prior art; and

FIG. 11 is a timing chart of another prior art.

### DESCRIPTION OF THE PREFERRED EMBODIMENTS

### First Embodiment

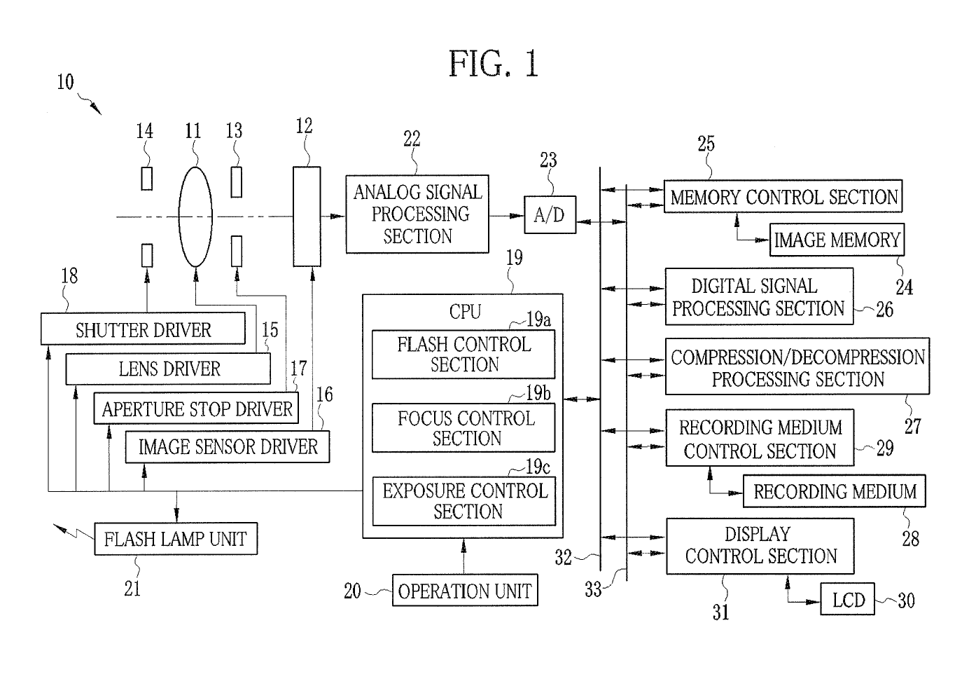

As shown in FIG. 1, a digital camera 10 is provided with a taking lens 11, a CCD image sensor 12, an aperture stop 13 disposed between the taking lens 11 and the CCD image sensor 12, and a mechanical shutter 14 disposed in front of the taking lens 11. To the taking lens 11, a lens driver 15 is connected. To the CCD image sensor 12, an image sensor driver 16 is connected. An aperture stop driver 17 is connected to the aperture stop 13, and a shutter driver 18 is connected to the mechanical shutter 14.

A CPU 19 controls the whole electric control system of the digital camera 10 based on an operation signal from an operation unit 20. The CPU 19 includes a flash control section 19a, a focus control section 19b, and an exposure control section 19c. The flash control section 19a controls the timing and amount of flash light emission from a flash lamp unit 21. The focus control section 19b commands the lens driver 15 to shift the taking lens 11 to obtain correct focus. The exposure control section 19c determines an f-stop number and a shutter speed (exposure value EV), and sends command signals to the aperture stop driver 17 and the image sensor driver 16. The image sensor driver 16 drives the CCD image sensor 12 based on the command signal. Thus, the CCD image sensor 12 captures an object image through the taking lens 11, and outputs an image signal.

The digital camera 10 is provided with an analog signal processing section 22 and an analog-to-digital converter (A/D) 23, which are controlled by the CPU 19. The analog signal processing section 22 applies various analog signal processes including correlated double sampling to the image signal outputted from the CCD image sensor 12. The A/D 23 converts an output signal (RGB color signals) from the analog signal processing section 22 into a digital signal.

The digital camera 10 is also provided with a memory control section 25 connected to an image memory 24, a digital signal processing section 26, a compression/decompression processing section 27, a recording medium control section 29, and a display control section 31. The digital signal processing section 26 carries out a color interpolation process, a gamma correction process, an RGB/YC conversion process, and the like, in addition to a noise correction process and an image composition process described later on. The compression/decompression processing section 27 compresses image data into a JPEG file, and decompresses the JPEG file. The recording medium control section 29 writes the JPEG file to a removable recording medium 28, and reads the JPEG file from the recording medium 28. The display control section 31 controls display of the image data and the like on a liquid crystal display (LCD) 30 provided on a rear face of a camera body. Every part described above is connected to one another through a control bus 32 and a data bus 33, and is controlled by the CPU 19.

The operation unit 20 includes a shutter release button for carrying out shutter release operation, a mode dial for switching among a plurality of operation modes, a menu button for displaying setting items on the LCD 30, an enter button for choosing and entering the setting item, and the like. A user's command from the operation unit 20 is inputted to the CPU 19 as the operation signal. The CPU 19 carries out various control operations in response to the operation signal.

The shutter release button is a two-step button switch. With the use of auto-focusing (AF) and auto-exposure (AE) functions, the focus control section 19b and the exposure control section 19c carry out an AF process and an AE process, respectively, in response to a half push of the shutter release button. Then, upon a full push of the shutter release button, the CCD image sensor 12 captures the object image.

The digital camera 10 has a plurality of operation modes, among which the digital camera 10 is switchable with the mode dial. The operation modes include “a wide dynamic range mode” for capturing an image having a wide dynamic range, and “a high resolution mode” for capturing an image of high resolution without widening the dynamic range, and the like.

In the wide dynamic range mode, the dynamic range is chosen among, for example, 200%, 400%, and 800%. Also, whether or not to emit flash light from the flash lamp unit 21 is set with the operation unit 20.

In flash photography, the flash control section 19a makes the flash lamp unit 21 emit the flash light with timing described later, in synchronization with the full push of the shutter release button.

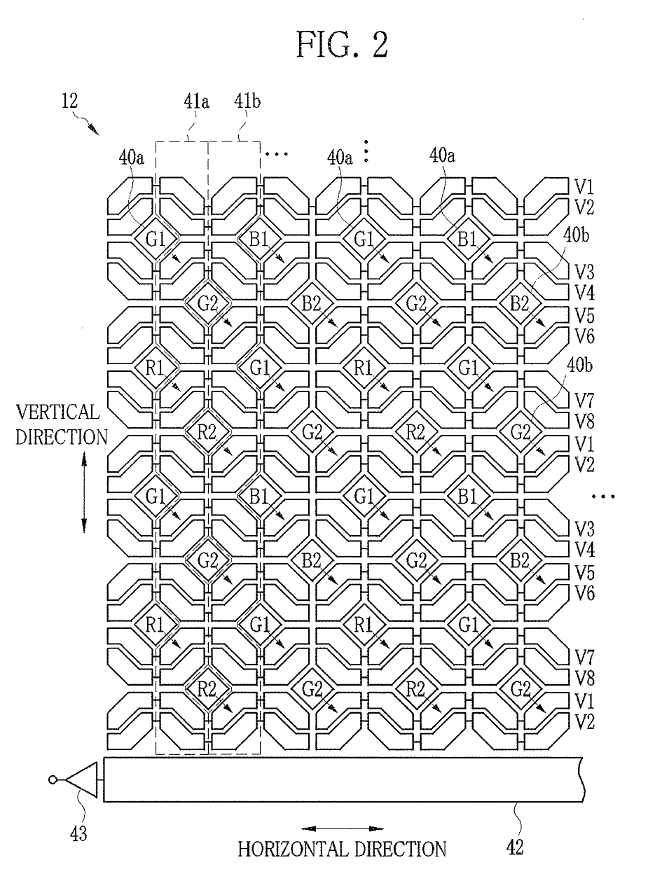

As shown in FIG. 2, the CCD image sensor 12 is fabricated on a semiconductor substrate along vertical and horizontal directions. The CCD image sensor 12 is constituted of a plurality of light receiving elements (photodiodes) 40, a plurality of vertical charge coupled devices (VCCDs) 41, a horizontal charge coupled device (HCCD) 42, and an output section 43. Each light receiving element 40 photoelectrically converts object light into a signal charge. Each VCCD 41 transfers the signal charges generated by the light receiving elements 40 in a vertical direction. The HCCD 42 is connected to an end of every VCCD 41, to transfer the signal charges that have been vertically transferred by the VCCDs 41 in the horizontal direction. The output section 43 converts the signal charges transferred by the HCCD 42 into an analog signal, and outputs the analog signal.

The light receiving elements 40 include first light receiving elements 40a indicated with R1, G1, and B1, and second light receiving elements 40b indicated with R2, G2, and B2. The first light receiving elements 40a are arranged in a tetragonal lattice structure. The second light receiving elements 40b are also arranged in the tetragonal lattice structure at the same intervals as that of the first light receiving elements 40a. The first and second light receiving elements 40a and 40b are staggered in both of the vertical and horizontal directions, so as to have a so-called honeycomb structure on the whole.

The first light receiving elements 40a have a Bayer color filter, in which green (G1) and blue (B1) are alternately arranged in one direction, and the green (G1) and red (R1) are alternately arranged in a direction orthogonal thereto. Likewise, the second light receiving elements 40b also have a Bayer color filter, in which green (G2) and blue (B2) are alternately arranged in one direction, and green (G2) and red (R2) are alternately arranged in a direction orthogonal thereto. Thus, the first and second light receiving elements 40a and 40b have a double-Bayer color filter on the whole, into which the two Bayer color filters are combined. Every light receiving element 40a, 40b is composed of a photodiode, and basically has the same structure (same device size, opening size, junction depth, charge storage capacity, and the like), except for the color of the color filter.

A first VCCD 41a is provided for every single column of the first light receiving elements 40a in the vertical direction. A second VCCD 41b is provided for every single column of the second light receiving elements 40b in the vertical direction. As schematically shown by arrows in FIG. 2, charge reading gates are formed between each first light receiving element 40a and a charge transfer channel (not illustrated) of the first VCCD 41a, and between each second light receiving element 40b and a charge transfer channel (not illustrated) of the second VCCD 41b. Thus, first and second signal charges generated by and accumulated in the first and second light receiving elements 40a and 40b, respectively, for the exposure times are read into the charge transfer channels of the first and second VCCDs 41a and 41b through the charge reading gates.

The charge transfer channels of the first and second VCCDs 41a and 41b are curvedly routed along the vertical direction so as to navigate around the first and second light receiving elements 40a and 40b in a surface layer of the semiconductor substrate. On a surface of the semiconductor substrate, vertical transfer electrodes V1 to V8 are curvedly formed along the horizontal direction across the charge transfer channels of the first and second VCCDs 41a and 41b so as to navigate around the first and second light receiving elements 40a and 40b. The first and second VCCDs 41a and 41b are driven by vertical transfer pulses φV1 to φV8, which are supplied by the image sensor driver 16 to the vertical transfer electrodes V1 to V8, respectively.

The charge reading gates of the first light receiving elements 40a adjoin the vertical transfer electrodes V3 and V7. The charge reading gates of the second light receiving elements 40b adjoin the vertical transfer electrodes V1 and V5. Thus, to read the first signal charges from the first light receiving elements 40a to the charge transfer channels of the first VCCDs 41a, a readout pulse is applied to the vertical transfer electrodes V3 and V7. Likewise, to read the second signal charges from the second light receiving elements 40b to the charge transfer channels of the second VCCDs 41b, a readout pulse is applied to the vertical transfer electrodes V1 and V5. The signal charges, as described above, are separately read out from the first and second light receiving elements 40a and 40b with different timing by the application of the readout pulse to the different vertical transfer electrodes.

The HCCD 42 is constituted of a charge transfer channel and a plurality of horizontal transfer electrodes formed on the charge transfer channel, though neither is illustrated. The HCCD 42 is driven by two phase horizontal transfer pulses φH1 and φH2 outputted from the image sensor driver 16. The output section 43 connected to an end of the HCCD 42 is constituted of an FD amplifier. The FD amplifier includes a floating diffusion section for converting the signal charge into a voltage and a source follower circuit.

Also, the CCD image sensor 12 has vertical overflow drains (VODs) through which electric charges needlessly accumulated in the first and second light receiving elements 40a and 40b are discharged into the semiconductor substrate. A charge reset function by the VODs is referred to as an electronic shutter. In response to electronic shutter pulses φSUB inputted from the image sensor driver 16 to the semiconductor substrate, a potential barrier formed in the bottom of each of the first and second light receiving elements 40a and 40b is reduced, so as to discharge the accumulated electric charge into the semiconductor substrate at a time.

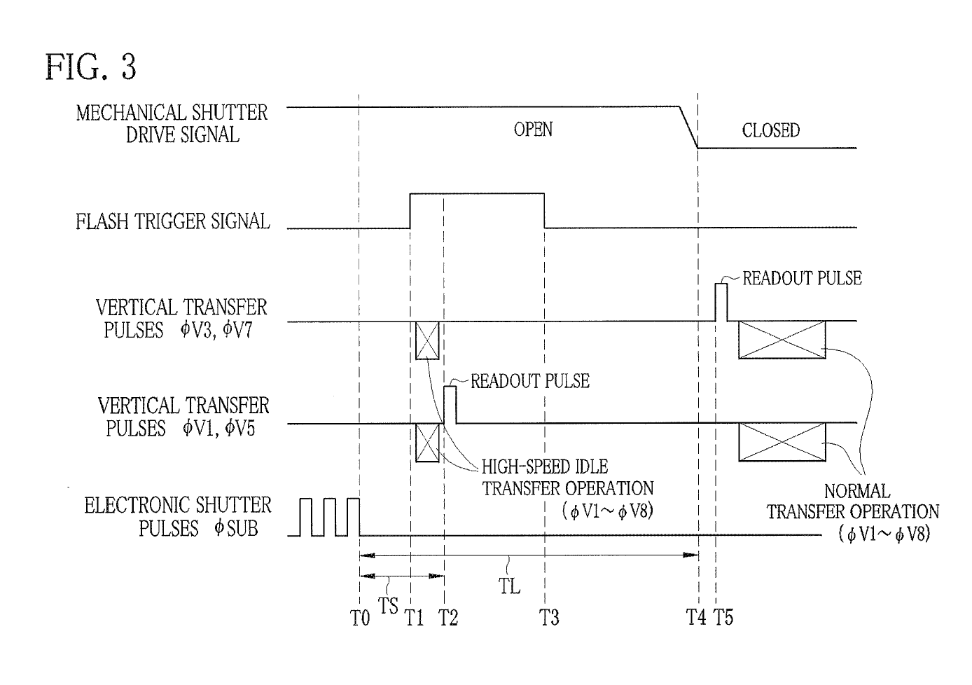

Next, a control method of the CCD image sensor 12, the mechanical shutter 14, and the flash lamp unit 21 in the flash photography in a wide dynamic range mode will be described. As shown in FIG. 3, while the mechanical shutter 14 is kept open, application of the electronic shutter pulses φSUB is stopped at T0 to start exposure of the first and second light receiving elements 40a and 40b.

The mechanical shutter 14 is closed at T4 after a lapse of predetermined time from start of the exposure. At T5 after T4, the first signal charges are read out from the first light receiving elements 40a in response to the application of the readout pulse to the vertical transfer electrodes V3 and V7. Thus, the exposure time (long exposure time) TL of the first light receiving elements 40a is defined as a period from T0 to T4.

The second signal charges, on the other hand, are read out from the second light receiving elements 40b at T2, within the exposure time TL of the first light receiving elements 40a, in response to the application of the readout pulse to the vertical transfer electrodes V1 and V5. The exposure time (short exposure time) TS of the second light receiving elements 40b is defined as a period from T0 to T2.

The second signal charges that have been readout at T2 from the second light receiving elements 40b are held in the second VCCDs 41b. After the first signal charges are read out at T5 to the first VCCDs 41a, vertical transfer pulses φV1 to φV8 and horizontal transfer pulses φH1 and φH2 are applied, so that the first and second VCCDs 41a and 41b and the HCCD 42 transfer the first and second signal charges to the output section 43 (normal transfer operation). The second signal charges readout from the second light receiving elements 40b, however, contain noise charges that have occurred by intensive incident light due to the flash light, while the second signal charges are being held in the second VCCDs 41b, that is, between T2 and T4, as it will be described later in detail. The output section 43 converts the signal charges into an image signal of a single frame, and outputs the image signal.

Immediately before T2, in other words, immediately before the read of the second signal charges from the second light receiving elements 40b, high-speed idle transfer operation is carried out in the first and second VCCDs 41a and 41b and the HCCD 42, by the application of the vertical transfer pulses φV1 to φV8 and the horizontal transfer pulses φH1 and φH2 at higher frequency than that of the normal transfer operation. Thus, a noise signal produced by noise charges accumulated by smear or blooming in the first and second VCCDs 41a and 41b for the short exposure time TS is outputted from the output section 43.

A flash trigger signal for actuating the flash lamp unit 21 is applied from T1 to 13, so that a period of flash light emission is within the long exposure time TL and partially overlaps the short exposure time TS. The timing of T1 and T3 is so determined by the flash control section 19a that the ratio between the flash light amount produced during the long exposure time TL and the flash light amount produced during the short exposure time TS coincides with the ratio between the long exposure time TL and the short exposure time TS. The flash control section 19a may determine the timing of T1 and T3 with referring to a table that shows the relation between the timing of T1 and T3 and the ratio between the long and short exposure times TL and TS.

The ratio between the long exposure time TL and the short exposure time TS is determined by the CPU 19 in accordance with a set value of the dynamic range. If the set value of the dynamic range is 400%, for example, the ratio between the long exposure time TL and the short exposure time TS is set at 4:1.

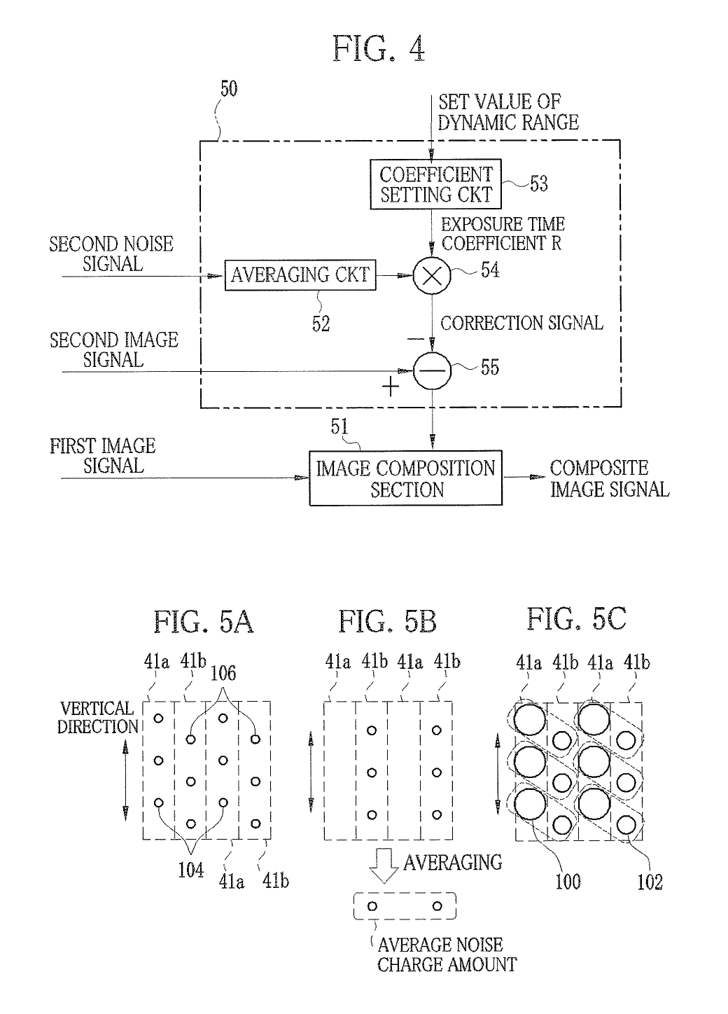

As shown in FIG. 4, the digital signal processing section 26 includes a noise correction section 50 and an image composition section 51. The noise correction section 50 is constituted of an averaging circuit 52, a coefficient setting circuit 53, a multiplier 54, and a subtractor 55.

FIG. 5A schematically shows first noise charges 104 accumulated in the first VCCDs 41a for the short exposure time TS, and second noise charges 106 accumulated in the second VCCDs 41b for the short exposure time TS. By the high-speed idle transfer operation just before T2, the noise signal is outputted. The noise signal includes a first noise signal produced from the first noise charges 104 and a second noise signal produced from the second noise charges 106. The first and second noise signals are written to the image memory 24. The second noise signal is also inputted to the averaging circuit 52 of the noise correction section 50. The averaging circuit 52, as shown in FIG. 5B, averages the second noise signal, that is, noise charge amounts accumulated in the second VCCDs 41b, on a second VCCD 41b basis, to calculate an average noise signal. In this embodiment, the averaging circuit 52 averages, for example, the amounts of two thousand noise charges, the number of which corresponds to the total number of the second light receiving elements 40b aligned in the vertical direction, on a second VCCD 41b basis.

As described above, the ratio between the flash light amount produced during the long exposure time TL and the flash light amount produced during the short exposure time TS is equal to the ratio between the long exposure time TL and the short exposure time TS. Thus, the ratio between the noise charge amount accumulated in the second VCCD 41b for the long exposure time TL and that for the short exposure time TS due to the flare and blooming equates to the ratio between the long exposure time TL and the short exposure time TS.

The CPU 19 sets an exposure time coefficient R on the coefficient setting circuit 53. The exposure time coefficient R is defined as TL/TS−1, and is calculated by the ratio between the long exposure time TL and the short exposure time TS. Taking a case where the set value of the dynamic range is 400% as an example, since the ratio between the long exposure time TL and the short exposure time TS is 4:1, “3” is set on the coefficient setting circuit 53 as the exposure time coefficient R. The multiplier 54 multiplies the average noise signal by the exposure time coefficient R set on the coefficient setting circuit 53, to produce a correction signal (second correction signal). In the case of the exposure time coefficient R of “3”, the correction signal is a triple of the average noise signal. This correction signal mathematically corresponds to the noise charge amounts accumulated in the second VCCD 41b in a period from T2 to T4.

FIG. 5C schematically shows electric charges held at T5 by the first and second VCCDs 41a and 41b. To the first VCCDs 41a, first signal charges 100 generated by the first light receiving elements 40a during the long exposure time TL are read out in response to a readout pulse at T5. Each electric charge 102 held in the second VCCDs 41b is an addition of the noise charge that has accumulated in the second VCCDs 41b between T2 and T4 to the second signal charge read out at T2 from the second light receiving element 40b.

A first image signal is produced from the first signal charges 100 of the first VCCDs 41a, and a second image signal is produced from the electric charges 102 of the second VCCDs 41b. The first and second image signals are recorded on the image memory 24. The subtractor 55 subtracts the corresponding correction signal from the second image signal on a second VCCD 41b basis. The correction signal, as described above, corresponds to the noise charges accumulated in each second VCCD 41b between T2 and T4. Accordingly, the subtraction eliminates the effect of the noise charges from the second image signal, and brings about obtainment of the corrected second image signal that corresponds to only the second signal charges.

The image composition section 51 merges the first image signal (long exposure image signal) with the corrected second image signal (short exposure image signal), so as to merge the electric charges from the first and second light receiving elements 40a and 40b having the same color filter from pair to pair, as shown by broken lines in FIG. 5C. The first image signal is high-sensitivity image data by the long exposure, and the second image signal is low-sensitivity image data by the short exposure. To carry out a merge process, as disclosed in Japanese Patent Laid-Open Publication No. 2007-235656, after a saturation voltage of the high-sensitivity image data is equalized with that of the low-sensitivity image data by signal slicing, data of the corresponding pixels of the same color is added up, and a composite signal becomes image data having a wide dynamic range. The digital signal processing section 26 applies to the image data the color interpolation process, the gamma correction process, the RGB/YC conversion process, and the like, as described above.

In the high resolution mode, the CPU 19 drives the second light receiving elements 40b at the same timing as the first light receiving elements 40a, to equate the exposure times of both of the first and second light receiving elements 40a and 40b. In this case, the high-speed idle transfer operation is not carried out before T2. The high-speed idle transfer operation is carried out between T4 and T5 instead, to refresh the VCCDs 41. In the high resolution mode, the digital signal processing section 26 does not carry out the noise correction process and the image composition process as described above, but treats every first and second light receiving elements 40a and 40b as an equal pixel to produce image data of high resolution.

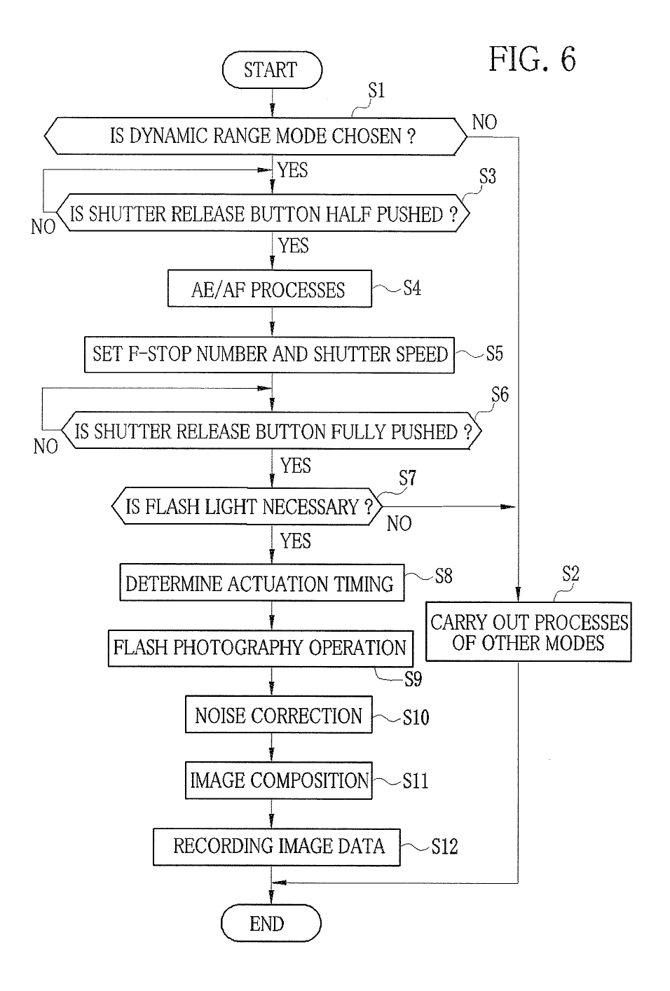

Next, the operation of the digital camera 10 will be described with referring to a flowchart of FIG. 6. The CPU 19 first judges whether or not the wide dynamic range mode is chosen with the mode dial (S1). If the wide dynamic range mode is chosen (YES in S1), steps S3 to S12 are carried out. If another mode is chosen (NO in S1), processes of the chosen mode are carried out (S2).

Upon detecting the half push of the shutter release button (YES in S3), the CPU 19 notifies the focus control section 19b and the exposure control section 19c of the detection of the half push. In response to the notification, the exposure control section 19c carries out the AE process, and the focus control section 19b carries out the AF process (S4). The CPU 19 sets the f-stop number and the shutter speed (EV) based on a result of the AE process (S5).

The shutter speed determines the long exposure time TL of the first light receiving elements 40a. The short exposure time TS of the second light receiving elements 40b is determined based on the set value of the dynamic range. For example, if the set value of the dynamic range is 200%, “TS=TL/2” holds. If the set value of the dynamic range is 400%, “TS=TL/4” holds. If the set value of the dynamic range is 800%, “TS=TL/8” holds. The set value of the dynamic range is manually inputted with the operation unit 20, but may be automatically set in accordance with a photographed scene or the like.

Then, in response to detection of the full push of the shutter release button (YES in S6), the CPU 19 judges whether or not the flash light from the flash lamp unit 21 is necessary (S7). If the flash light is unnecessary (NO in S7), processes of a non-flash light mode are carried out (S2).

If the flash light is necessary (YES in S7), on the other hand, the CPU 19 determines the timing T1 to T5 of actuation of individual parts illustrated in FIG. 3 (S8). The CPU 19 actuates the CCD image sensor 12, the mechanical shutter 14, and the flash lamp unit 21 to carry out flash photography operation as described above (S9). The first and second noise signals and the first and second image signals outputted from the CCD image sensor 12 are processed by the analog signal processing section 22 and the A/D converter 23, and are written to the image memory 24 by the memory control section 25.

Then, the digital signal processing section 26 reads the first and second noise signals and the first and second image signals from the image memory 24. The noise correction section 50 carries out the above noise correction process (S10). In the noise correction process, the correction signal is produced based on the second noise signal obtained by the high-speed idle transfer operation. This correction signal corresponds to the amount of noise charges that are needlessly accumulated between T2 and T4 shown in FIG. 3 due to the effect of the flash light. The correction signal is subtracted from the second image signal outputted from the second light receiving elements 40b.

The first image signal and the corrected second image signal are merged by the image composition section 51 to obtain the image data having the wide dynamic range (S11). The image data is subjected to the various signal processes and a compression process, and is then written to the recording medium 28 by the recording medium control section 29 (S12).

### Second Embodiment

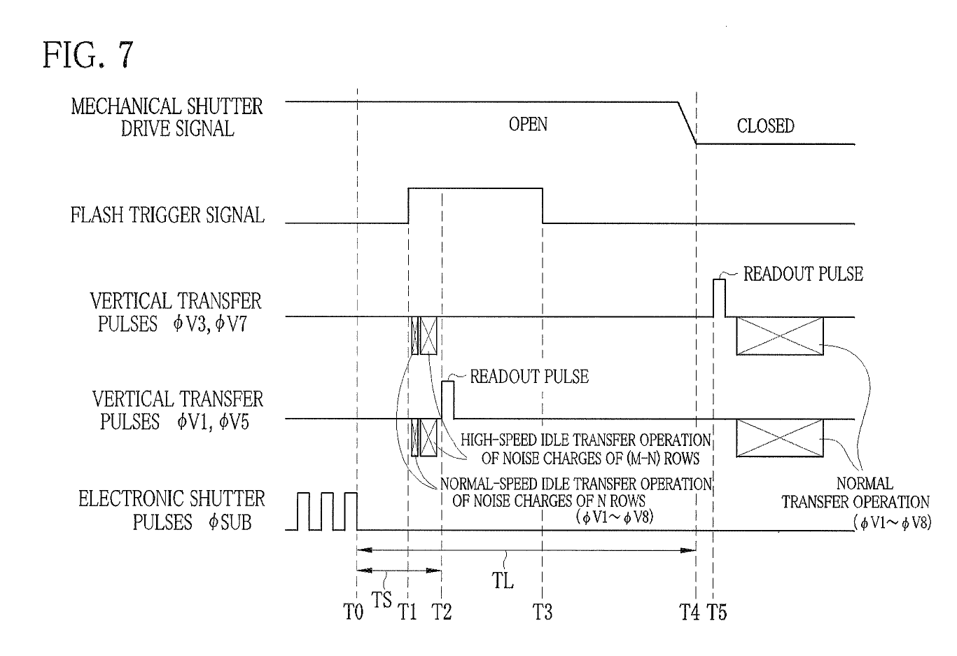

In the first embodiment, the second noise signal is produced from a total row number (for example, two thousand) of noise charges that are transferred by the high-speed idle transfer operation just before T2, that is, just before reading out the signal charges from the second light receiving elements 40b. In a second embodiment, when M refers to the total row number of the second light receiving elements 40b, a first N number (for example, twenty) of noise charges are transferred by the idle transfer operation at a normal frequency, and then a remaining (M−N) number of noise charges are transferred by the high-speed idle transfer operation at a high frequency just before T2, as shown in FIG. 7.

The second noise signal is produced from the N number of noise charges transferred by the idle transfer operation at normal speed. The CPU 19 writes the second noise signal to the image memory 24, and abandons a signal produced from the noise charges transferred by the high-speed idle transfer operation. The averaging circuit 52 of the noise correction section 50 averages the second noise signal on a second VCCD 41b basis, and outputs the average noise signal. The multiplier 54 multiplies the average noise signal by the exposure time coefficient R set on the coefficient setting circuit 53, to obtain the correction signal. Since the noise charges accumulated in the same VCCD hardly vary in general in the vertical direction, even the correction signal produced from only the N number of noise charges has sufficient accuracy. The other components of the second embodiment are the same as those of the first embodiment, and description thereof will be omitted.

As described above, in the second embodiment, the second noise signal is produced from the N number of noise charges transferred at the normal speed. Thus, the noise charges are less prone to degradation in comparison with the case of transferring a large number of noise charges at the high speed, and hence the correction signal with high accuracy is obtained. This results in improvement in accuracy of the image data having the wide dynamic range.

### Third Embodiment

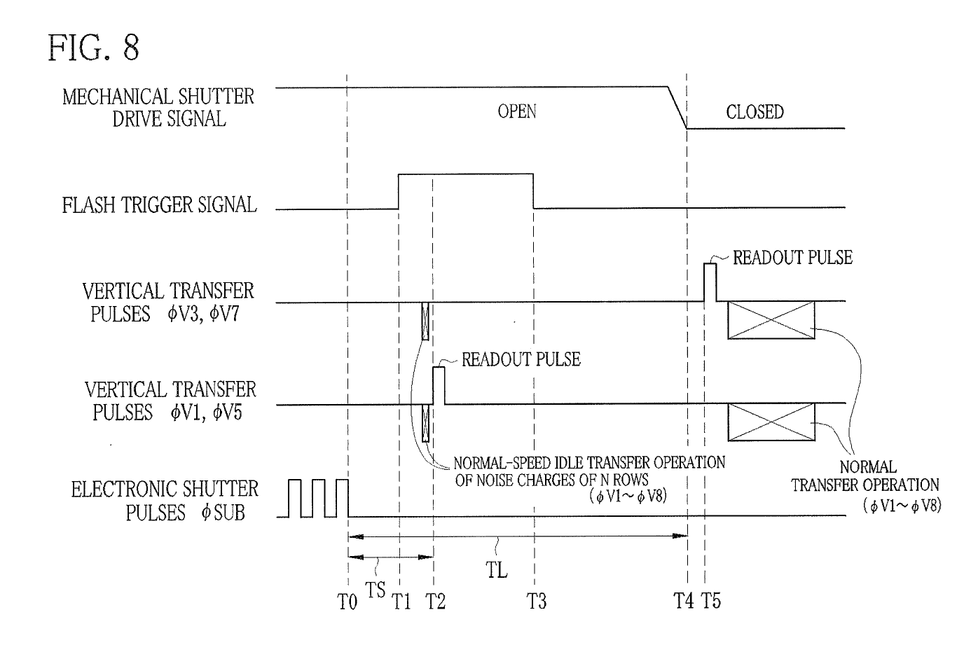

In a third embodiment, when M refers to the total row number of the second light receiving elements 40b, a first N number of noise charges are transferred at the normal speed just before T2, that is, just before reading out the signal charges from the second light receiving elements 40b, as shown in FIG. 8, while a remaining (M−N) number of noise charges are not transferred. In this case, out of the noise charges accumulated in the second VCCD 41b by T2, only the N number of noise charges are transferred, while the remaining (M−N) number of noise charges remain in the second VCCD 41b. Thus, the (M−N) number of noise charges remaining in the second VCCD 41b are added to the second signal charges read out from the second light receiving elements 40b.

The number N is set smaller than the number M (for example, M=2000 and N=20). Thus, at T2, most of the noise charges that have been accumulated during the short exposure time TS remain in the second VCCD 41b. Accordingly, in the third embodiment, the noise correction section 50 produces the correction signal that corresponds to the noise charges accumulated in a period between T0 and T4 in the second VCCD 41b. To be more specific, an exposure time coefficient R′=TL/TS is set on the coefficient setting circuit 53, instead of the exposure time coefficient R=TL/TS−1. The other components of the third embodiment are the same as those of the first embodiment, and description thereof will be omitted.

As described above, in the third embodiment, since only the N number of noise charges are transferred between T0 and T2, the short exposure time TS of the second light receiving elements 40b can be more shortened. Therefore, the variable range of the ratio between the long exposure time TL and the short exposure time TS becomes wider, and a wider dynamic range can be obtained.

### Fourth Embodiment

In the above first embodiment, out of the first and second image signals outputted from the CCD image sensor 12, noise correction is applied to only the second image signal, being the short exposure image signal. In a fourth embodiment, the noise correction is applied not only to the second image signal but also to the first image signal, being the long exposure image signal.

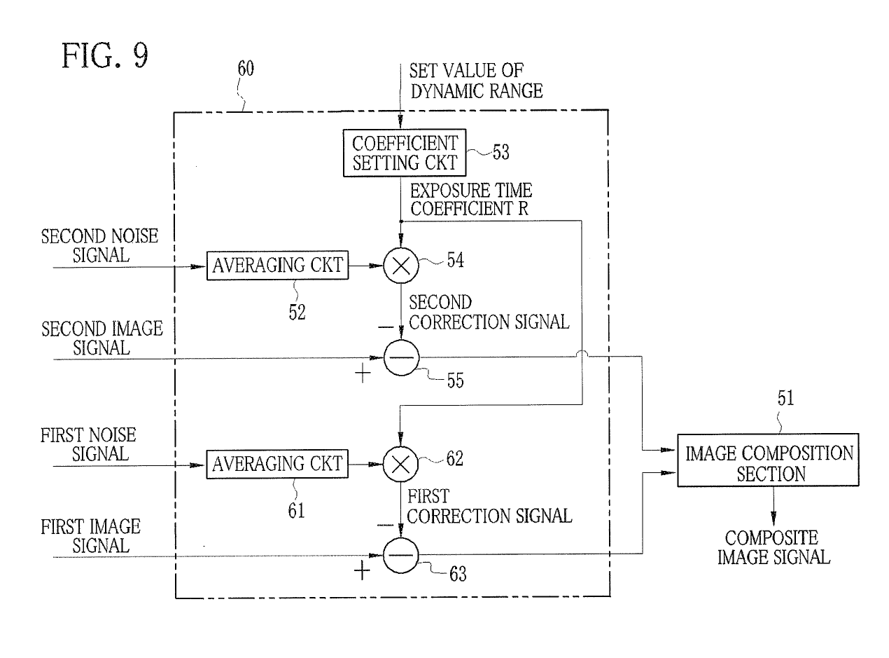

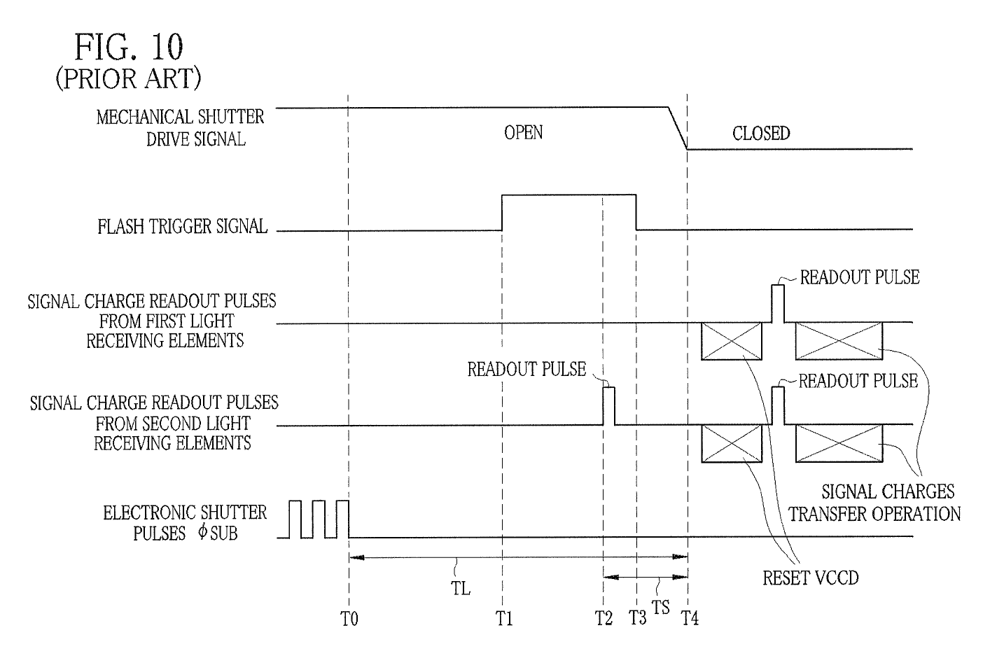

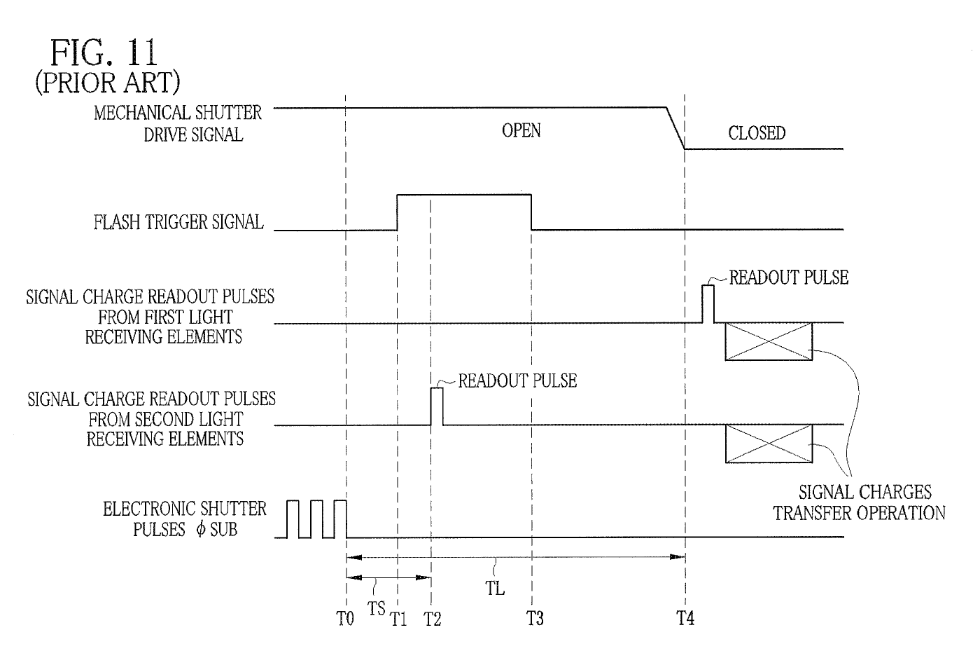

FIG. 9 shows a noise correction section 60 according to the fourth embodiment. The noise correction section 60 is identical to the noise correction section 50 of the first embodiment, except that it has another averaging circuit 61, multiplier 62, and subtractor 63 for processing the first image signal.

The averaging circuit 61, as with the averaging circuit 52, averages the noise charges that have been accumulated in the first VCCDs 41a, that is, the first noise signal on a first VCCD 41a basis, and calculates an average noise signal. The multiplier 62 multiplies the average noise signal by the exposure time coefficient R set on the coefficient setting circuit 53 to obtain a correction signal (first correction signal). The subtractor 63 subtracts the correction signal from the first image signal. As for the second image signal, the averaging circuit 52, the multiplier 54, and the subtractor 55 carry out the noise correction, as in the case of the first embodiment.

To the image composition section 51, the first and second image signals corrected by the noise correction section 60 are inputted. The image composition section 51 produces image data having a wide dynamic range by the composition process as described above. The other components of the fourth embodiment are the same as those of the first embodiment, and description thereof will be omitted.

As described above, in the fourth embodiment, since the noise correction is applied not only to the second image signal being the short exposure image signal but also to the first image signal being the long exposure image signal. This results in improvement in accuracy of the image data having the wide dynamic range. The noise correction section 60 may be apply to the second and third embodiments, in order to remove noise from the first image signal, in addition to the second image signal.

In the first to fourth embodiments, before reading out the signal charges from the first light receiving elements 40a, the mechanical shutter 14 is closed at T4 to define an end of the long exposure time TL. However, the end of the long exposure time TL may be defined by the timing T5 of input of the readout pulse for reading out the signal charges from the first light receiving elements 40a, instead of closing the mechanical shutter 14.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. An image capture device comprising:
a flash lamp unit for emitting flash light;
a CCD image sensor including:
first light receiving elements for capturing a long exposure image;
second light receiving elements for capturing a short exposure image;
first VCCDs, first signal charges being read out from the first light receiving elements to the first VCCDs, for transferring the read first signal charges in a vertical direction;
second VCCDs, second signal charges being read out from the second light receiving elements to the second VCCDs at a time different from the readout of the first signal charges, for transferring the read second signal charges in the vertical direction;
a HCCD connected to an end of each of the first and second VCCDs, for transferring in a horizontal direction the first and second signal charges transferred through the first and second VCCDs; and
an output section for converting the first and second signal charges transferred through the HCCD into an analog signal, and outputting the analog signal;
an exposure control section for controlling an exposure of the CCD image sensor, the exposure control section making the CCD image sensor produce a first image signal from the first signal charges read out from the first light receiving elements after the exposure for a long exposure time, making the CCD image sensor produce a second image signal from the second signal charges read out from the second light receiving elements after the exposure for a short exposure time, making the CCD image sensor produce a first noise signal from first noise charges accumulated in the first VCCDs, and making the CCD image sensor produce a second noise signal from second noise charges accumulated in the second VCCDs;
a flash control section for controlling timing of flash light emission from the flash lamp unit, so as to equate a ratio between a flash light amount produced during the long exposure time and a flash light amount produced during the short exposure time with a ratio between the long exposure time and the short exposure time;
a noise correction section for removing noise from the second image signal based on the second noise signal; and
an image composition section for merging the first image signal with the second image signal after correction by the noise correction section to produce image data.

2. The image capture device according to claim 1, wherein the exposure control section starts the exposure of the first and second light receiving elements at the same time;
after a lapse of the short exposure time, the second signal charges are read out from the second light receiving elements to the second VCCDs, and held in the second VCCDs;
after a lapse of the long exposure time, the first signal charges are read out from the first light receiving elements to the first VCCDs, and transferred together with the second signal charges having been held in the second VCCDs by normal transfer operation;
just before the readout of the second signal charges from the second light receiving elements, the first and second VCCDs and the HCCD are driven to transfer the first and second noise charges having accumulated during the short exposure time in the first and second VCCDs by idle transfer operation; and
the noise correction section calculates a second correction signal by multiplying the second noise signal produced from the second noise charges by a coefficient obtained based on the ratio between the long exposure time and the short exposure time, and subtracts the second correction signal from the second image signal, and outputs the corrected second image signal,
wherein the second correction signal corresponds to an amount of noise charges added to the second signal charges, while the second signal charges are held in the second VCCDs.

3. The image capture device according to claim 2, wherein the noise correction section calculates a first correction signal by multiplying the first noise signal produced from the first noise charges by the coefficient obtained based on the ratio between the long exposure time and the short exposure time, and subtracts the first correction signal from the first image signal, and outputs the corrected first image signal,
wherein the first correction signal corresponds to an amount of noise charges accumulated in the first VCCDs until an end of the long exposure time; and
the image composite section merges the corrected first image signal with the corrected second image signal to produce the image data.

4. The image capture device according to claim 2, wherein a speed of the idle transfer operation is higher than that of the normal transfer operation.

5. The image capture device according to claim 2, wherein each of the first and second VCCDs has a plurality of rows;
in the idle transfer operation, out of all of the rows included in each of the first and second VCCDs, the first and second noise charges accumulated in a beginning predetermined number of rows are transferred at a normal speed, while the first and second noise charges accumulated in the remaining rows are transferred at a high speed; and
the first and second noise signals are produced from the first and second noise charges transferred at the normal speed, respectively.

6. The image capture device according to claim 2, wherein each of the first and second VCCDs has a plurality of rows;
in the idle transfer operation, out of all of the rows included in each of the first and second VCCDs, the first and second noise charges accumulated in a beginning predetermined number of rows are transferred at a normal speed, while the first and second noise charges accumulated in the remaining rows are left in the first and second VCCDs without being transferred; and
the first and second noise signals are produced from the transferred first and second noise charges, respectively.

7. The image capture device according to claim 1, wherein the CCD image sensor has an electronic shutter function for simultaneously discharging the first and second signal charges accumulated in the first and second light receiving elements into a semiconductor substrate for reset, and activates the electronic shutter function before starting the exposure of the first and second light receiving elements.

8. The image capture device according to claim 1, further comprising:
an operation unit for setting a value of a dynamic range, the ratio between the long exposure time and the short exposure time being determined based on the set value of the dynamic range.

9. The image capture device according to claim 1, wherein in the CCD image sensor, the first light receiving elements are arranged in a matrix along the vertical and horizontal directions, and the second light receiving elements are arranged in a matrix at a same pitch as that of the first light receiving elements along the vertical and horizontal directions, and the first and second light receiving elements are staggered in the vertical and horizontal directions;
the first and second VCCDs extending in the vertical direction are disposed alternately in the horizontal direction; and
the HCCD extends in the horizontal direction.

10. The image capture device according to claim 9, wherein a Bayer color filter including blue, green, and red is disposed on the first light receiving elements, and another Bayer color filter including blue, green, and red is disposed on the second light receiving elements.

11. A method for controlling an image capture device having a flash lamp unit and a CCD image sensor, the CCD image sensor including first light receiving elements, second light receiving elements, first VCCDs for vertically transferring first signal charges read out from the first light receiving elements, second VCCDs for vertically transferring second signal charges read out from the second light receiving elements, a HCCD connected to an end of each of the first and second VCCDs to horizontally transfer the first and second signal charges, and an output section for converting the first and second signal charges transferred through the HCCD into an analog signal, the method comprising the steps of:
starting exposing the first and second light receiving elements at the same time;
just before a lapse of a short exposure time, driving the first and second VCCDs and the HCCD to transfer first noise charges accumulated in the first VCCDs and second noise charges accumulated in the second VCCDs by idle transfer operation, and producing a first noise signal from the first noise charges and producing a second noise signal from the second noise charges;
after the lapse of the short exposure time, reading out the second signal charges from the second light receiving elements to the second VCCDs, and holding the second signal charges in the second VCCDs;
after a lapse of a long exposure time, reading out the first signal charges from the first light receiving elements to the first VCCDs;
after the readout of the first signal charges, driving the first and second VCCDs and the HCCD to transfer the first signal charges read out from the first light receiving elements and the second signal charges held in the second VCCDs by normal transfer operation, and producing a first image signal from the first signal charges and producing a second image signal from the second signal charges;
controlling timing of flash light emission from the flash lamp unit so as to equate a ratio between a flash light amount produced during the long exposure time and a flash light amount produced during the short exposure time with a ratio between the long exposure time and the short exposure time;
calculating a second correction signal by multiplying the second noise signal by a coefficient based on the ratio between the long exposure time and the short exposure time, the second correction signal corresponding to an amount of noise charges added to the second signal charges, while the second signal charges are held in the second VCCDs;
subtracting the second correction signal from the second image signal, and outputting the corrected second image signal; and
merging the first image signal with the corrected second image signal to produce image data.
